(19) United States
(12) Patent Application Publication
(10) Pub. No.: US 2021/0190013 A1
(43) Pub. Date: Jun. 24, 2021

(54) ROCKET BRAKED BY AIR RECOVERED BY TURBINES AND DECELERATION METHOD FOR RECOVERY OF SAME

(71) Applicants: Yanshan University, Qinhuangdao (CN); Qinhuangdao Yanda Yihua Mechanical and Electrical Engineering Technology Research Institute Co., Ltd, Qinhuangdao City (CN)

(72) Inventors: Jingyi Zhao, Qinhuangdao (CN); Haoxuan Liu, Qinhuangdao (CN); Yalu Qin, Qinhuangdao (CN); Jiaheng Chen, Qinhuangdao (CN); Hai'ou Tang, Qinhuangdao (CN); Jianjun Wang, Qinhuangdao (CN); Zhiqian Zhao, Qinhuangdao (CN)

(21) Appl. No.: 17/109,654

(22) Filed: Dec. 2, 2020

(30) Foreign Application Priority Data
Dec. 2, 2019 (CN) 201911212662 .4

(51) Int. Cl. F02K 9/90

(52) U.S. Cl. CPC F02K 9/90

(57) ABSTRACT

The present disclosure discloses a rocket braked by air recovered by turbines and a deceleration method for recovery of the same. The rocket includes a first-stage rocket and a second-stage rocket, where the first-stage rocket includes a first-stage rocket fuselage sequentially provided with a movable baffle, an oxidizer chamber, a fuel chamber, a combustion chamber, and an ejection opening from top to bottom; after the first-stage rocket is separated from the second-stage rocket, the movable baffle of the first-stage rocket is opened to generate resistance for deceleration and adjustment on a descending posture; an air inlet in a turbine is exposed at the same time, and the turbine is turned on; and after a flameout of an engine, stored compressed air is downwards ejected from the bottom of the first-stage rocket to generate thrust for deceleration, so as to achieve safe landing of the rocket.

### TECHNICAL FIELD

The present disclosure relates to the field of air transportation, in particular to a rocket braked by air recovered by turbines and a deceleration method for recovery of the same.

### BACKGROUND

Recovery and reuse of carrier rockets can help reduce launch costs. It is well known that the costs of space launch have been high all the time. The carrier rockets cannot be reused after being used. It takes about 10000-20000 dollars to transport one kilogram of objects to the sky. In fact, fuel costs of the carrier rockets only account for about 1/200 of the launch costs, and the largest portions are navigation control systems, fuel tanks, and engines of the rockets. If the rockets can be reused, the launch costs can be greatly reduced. Therefore, the development tendency of aerospace is to manufacture reusable carrier rockets.

The SpaceX as an international representative of studying the recovery technologies of the rockets realizes a smooth landing of recovered rockets after four-time failed recovery of rockets. After a “Falcon 9” rocket transports a cargo spacecraft into space, a first-stage rocket vertically lands on an offshore platform. In such recovery technology, an engine of the rocket is used to achieve reverse thrust for deceleration to make the first-stage rocket received by the offshore platform.

In the recovery process of the “Falcon 9” rocket, a large amount of propellants are required by the deceleration by means of the engine of the rocket; moreover, a jet frame is prone to burning landing gear legs and a landing platform; and in this case, an explosion may easily occur. Consequentially, this recovery process is risky to a great extent.

### SUMMARY

The technical issue to be settled by the present disclosure is to provide a rocket braked by air recovered by turbines and a deceleration method for recovery of the same. In the descending process of the rocket, compressed air is delivered, by a triune, into upper spaces in a fuel chamber and an oxidizer chamber of the rocket. In a final stage of the descending process, the recovered air is downwards ejected at a high speed to generate reverse thrust for deceleration, so as to achieve safe landing.

To settle the above-mentioned technical issue, the present disclosure adopts the following technical solution:

A rocket braked by air recovered by turbines includes a first-stage rocket and a second-stage rocket, where the first-stage rocket includes a first-stage rocket fuselage sequentially provided with movable baffles, an oxidizer chamber, a fuel chamber, a combustion chamber, and an ejection opening from top to bottom; the movable baffles are movably hinged with the upper end of the first-stage rocket fuselage and are driven to be opened by hydraulic cylinders; turbines are arranged in the first-stage rocket fuselage and on internal walls of the movable baffles; and compressed air is delivered, by the turbines, into the first-stage rocket fuselage for storage and is downwards ejected via the ejection opening when the rocket descends to be close to the ground.

Further, troughs for mounting the turbines may be formed in the first-stage rocket fuselage and have upper edges hinged with upper ends of the movable baffles; each hydraulic cylinder may have one end hinged with the top of the corresponding trough and the other end hinged with the corresponding movable baffle; and the turbines may be arranged on the internal walls of the movable baffles.

Further, an oxidizer may be located below a piston separator in the oxidizer chamber, and fuel may be located below a piston separator in the fuel chamber; the turbines may be communicated, via air tubes, with a space above the piston separator in the oxidizer chamber as well as a space above the piston separator in the fuel chamber, so as to fulfill storage of the compressed air; and the air tubes may be provided with check valves for guiding the compressed air generated during operation of the turbines into the oxidizer chamber and the fuel chamber.

Further, the space storing the compressed air in the oxidizer chamber as well as the space storing the compressed air in the fuel chamber may be communicated with the ejection opening via an air outlet tube; valves in the air outlet tubes may be controlled to be opened and closed by a sensor in the first-stage rocket fuselage; the sensor may send a signal to open the valves when detecting that the rocket is about to reach the ground; and in this way, the compressed air may be ejected via the ejection opening to achieve deceleration, thus achieving safe landing of the rocket for recovery.

Further, four turbines and four movable baffles corresponding to the turbines may be uniformly arranged outside the first-stage rocket fuselage.

A deceleration method for recovery of a rocket braked by air recovered by turbines includes: separating a first-stage rocket from a second-stage rocket, and then opening a movable baffle of the first-stage rocket to generate resistance for deceleration and adjustment on a descending posture, where an air inlet in a turbine is exposed at the same time; turning on the turbine; driving an engine by means of residual fuel to achieve the deceleration in an initial stage, and after a flameout of the engine, downwards ejecting stored compressed air from the bottom of the first-stage rocket to generate thrust for deceleration, so as to achieve safe landing of the rocket.

Further, the deceleration method for recovery of the rocket braked by air recovered by turbines may particularly include:

step a, separating the first-stage rocket from the second-stage rocket, and then opening the movable baffle of the first-stage rocket to generate the resistance for the deceleration and the adjustment on the descending posture;

step b, turning on the turbine to generate the compressed air and then deliver the compressed air, via an air tube, into a space above a piston separator in an oxidizer chamber as well as a space above a piston separator in a fuel chamber; and

step c, driving the engine by means of the residual fuel to achieve the deceleration in the initial stage; and after the flameout of the engine, when a sensor detects that the rocket is about to reach the ground, opening a valve between the oxidizer chamber and an ejection opening as well as the fuel chamber and the ejection opening to make the compressed air be downwards ejected via the ejection opening from the bottom of the first-stage rocket, so as to generate the thrust for the deceleration, thus achieving safe landing of the rocket.

By adopting the above technical solution, the present disclosure has the following technical effects:

1. The movable baffle can be opened to generate air resistance, so that the descending posture of the rocket can be adjusted;

2. Deceleration fulfilled by the engine can be replaced with braking through air recovered by turbines, so that fuel consumption is reduced;

3. When the baffle is opened, the air resistance will be generated to achieve the deceleration; the deceleration before a landing is fulfilled by means of reverse thrust from high-pressure air, that is, safe landing is fulfilled; and in this way, a landing gear cannot be burned; and

4. The risk of explosion in the recovery process of the rocket is lowered, and the reliability of the recovery is improved.

### BRIEF DESCRIPTION OF DRAWINGS

FIG. 1 is a sectional front view of a first-stage rocket of the present disclosure;

FIG. 2 is a schematic diagram showing a separation state of the first-stage rocket and a second-stage rocket of the present disclosure;

FIG. 3 is a schematic diagram of a turbine set, in an unfolded state, of the present disclosure; and

FIG. 4 is a schematic diagram of a mounting structure of a turbine of the present disclosure.

In the figure, 1. first-stage rocket fuselage; 2. movable baffle, 3. oxidizer chamber, 4. fuel chamber, 5. combustion chamber, 6. ejection opening, 7. hydraulic cylinder, 8. turbine, 9. piston separator.

### DETAILED DESCRIPTION

The present disclosure is further described in detail below with reference to the following embodiments.

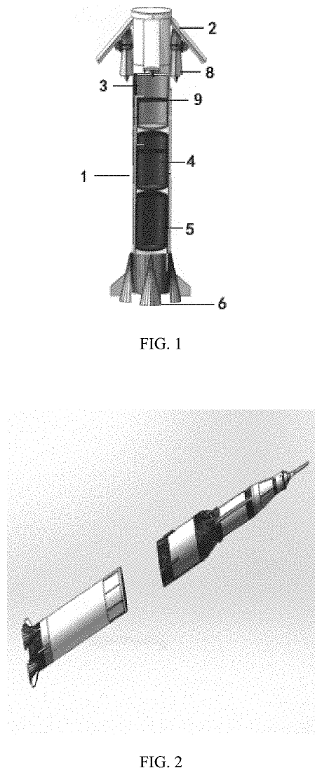

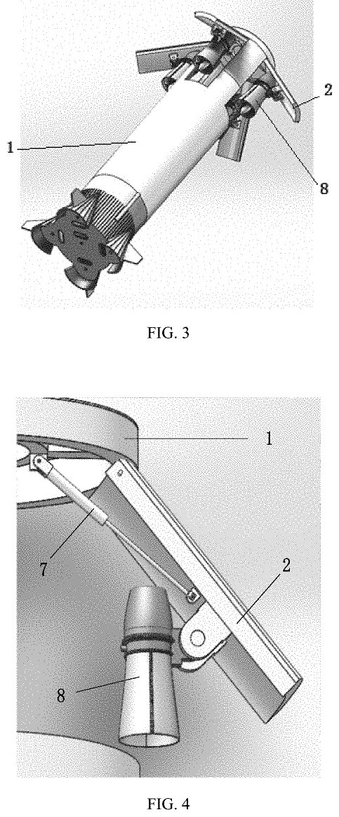

As shown in FIG. 1, a rocket braked by air recovered by turbines includes a first-stage rocket and a second-stage rocket, where the first-stage rocket includes a first-stage rocket fuselage 1 sequentially provided with movable baffles 2, an oxidizer chamber 3, a fuel chamber 4, a combustion chamber 5, and an ejection opening 6 from top to bottom; the movable baffles 2 are movably hinged with the upper end of the first-stage rocket fuselage 1 and are driven to be opened by hydraulic cylinders 7; turbines 8 are arranged in the first-stage rocket fuselage 1 and on internal walls of the movable baffles 2, and four turbines 8 and four movable baffles 2 corresponding to the turbines 8 are uniformly arranged outside the first-stage rocket fuselage 1; and compressed air is delivered, by the turbines 8, into the first-stage rocket fuselage 1 for storage and is downwards ejected via the ejection opening 6 when the rocket descends to be close to the ground.

Particularly, troughs for mounting the turbines 8 are formed in a side wall of the upper end of the first-stage rocket fuselage 1 and have upper edges hinged with upper ends of the movable baffles 2; each hydraulic cylinder 7 has one end hinged with the top of the corresponding trough and the other end hinged with the corresponding movable baffle 2; and the turbines 8 are arranged on the internal walls of the movable baffles 2; and

An oxidizer is located below a piston separator 9 in the oxidizer chamber 3, and fuel is located below a piston separator 9 in the fuel chamber 4; the turbines 8 are communicated, via air tubes, with a space above the piston separator 9 in the oxidizer chamber 3 as well as a space above the piston separator 9 in the fuel chamber 4, so as to fulfill storage of the compressed air; the air tubes are provided with check valves for guiding the compressed air generated during operation of the turbines into the oxidizer chamber and the fuel chamber; the space storing the compressed air in the oxidizer chamber 3 as well as the space storing the compressed air in the fuel chamber 4 is communicated with the ejection opening 6 via an air outlet tube; valves are arranged in the air outlet tubes respectively between the oxidizer chamber 3 and the ejection opening 6 and between the fuel chamber 4 and the ejection opening 6, and are controlled to be opened and closed by a height sensor in the first-stage rocket fuselage 1; the sensor sends a signal to open the valves when detecting that the rocket is about to reach the ground; and in this way, the compressed air is ejected via the ejection opening 6 to achieve deceleration, thus achieving safe landing of the rocket for recovery.

A deceleration method for recovery of a rocket braked by air recovered by turbines particularly includes:

Step a, separate a first-stage rocket from a second-stage rocket, and then opening a movable baffle 2 of the first-stage rocket to generate resistance for deceleration and adjustment on a descending posture;

Step b, turn on a turbine 8 to generate compressed air and then deliver the compressed air, via an air tube, into a space above a piston separator 9 in an oxidizer chamber 3 as well as a space above a piston separator 9 in a fuel chamber 4; and

Step c, drive an engine by means of residual fuel to achieve the deceleration in an initial stage; and after a flameout of the engine, when a sensor detects that the rocket is about to reach the ground, open valves respectively between the oxidizer chamber and ejection opening and between the fuel chamber and the ejection opening to make the compressed air be downwards ejected via the ejection opening from the bottom of the first-stage rocket, so as to generate thrust for deceleration, thus achieving safe landing of the rocket.

According to the present disclosure, the compressed air is obtained by the turbines by means of kinetic energy in a recovery process; in this way, energy recycling as well as reductions of hydrogen consumption and oxygen consumption is achieved; and safe landing is achieved, so that the risk of explosion is lowered fundamentally.

What is claimed is:

1. A rocket braked by air recovered by turbines, comprising a first-stage rocket and a second-stage rocket, wherein the first-stage rocket comprises a first-stage rocket fuselage (1) sequentially provided with movable baffles (2), an oxidizer chamber (3), a fuel chamber (4), a combustion chamber (5), and an ejection opening (6) from top to bottom; the movable baffles (2) are movably hinged with an upper end of the first-stage rocket fuselage (1) and are driven to be opened by hydraulic cylinders (7); turbines (8) are arranged in the first-stage rocket fuselage (1) and on internal walls of the movable baffles (2); and compressed air is delivered, by the turbines (8), into the first-stage rocket fuselage (1) for storage and is downwards ejected via the ejection opening (6) when the rocket descends to be close to the ground.

2. The rocket braked by air recovered by turbines according to claim 1, wherein troughs for mounting the turbines (8) are formed in the first-stage rocket fuselage (1) and have upper edges hinged with upper ends of the movable baffles (2); each said hydraulic cylinder (7) has one end hinged with a top of the corresponding trough and the other end hinged with the corresponding movable baffle (2); and the turbines (8) are arranged on the internal walls of the movable baffles (2).

3. The rocket braked by air recovered by turbines according to claim 1, wherein an oxidizer is located below a piston separator (9) in the oxidizer chamber (3), and fuel is located below a piston separator (9) in the fuel chamber (4); the turbines (8) are communicated, via air tubes, with a space above the piston separator (9) in the oxidizer chamber (3) as well as a space above the piston separator (9) in the fuel chamber (4), so as to fulfill storage of the compressed air; and the air tubes are provided with check valves for guiding the compressed air generated during operation of the turbines into the oxidizer chamber and the fuel chamber.

4. The rocket braked by air recovered by turbines according to claim 3, wherein the space storing the compressed air in the oxidizer chamber (3) as well as the space storing the compressed air in the fuel chamber (4) is communicated with the ejection opening (6) via an air outlet tube; valves in the air outlet tubes are controlled to be opened and closed by a sensor in the first-stage rocket fuselage (1); the sensor sends a signal to open the valves when detecting that the rocket is about to reach the ground; and in this way, the compressed air is ejected via the ejection opening (6) to achieve deceleration, thus achieving safe landing of the rocket for recovery.

5. The rocket braked by air recovered by turbines according to claim 1, wherein four turbines (8) and four movable baffles (2) corresponding to the turbines (8) are uniformly arranged outside the first-stage rocket fuselage (1).

6. A deceleration method for recovery of a rocket braked by air recovered by turbines, comprising: separating a first-stage rocket from a second-stage rocket, and then opening a movable baffle (1) of the first-stage rocket to generate resistance for deceleration and adjustment on a descending posture, wherein an air inlet in a turbine (8) is exposed at the same time; turning on the turbine (8); driving an engine by means of residual fuel to achieve the deceleration in an initial stage; and after a flameout of the engine, downwards ejecting stored compressed air from a bottom of the first-stage rocket to generate thrust for deceleration, so as to achieve safe landing of the rocket.

7. The deceleration method for recovery of the rocket braked by air recovered by turbines according to claim 6, particularly comprising:
step a, separating the first-stage rocket from the second-stage rocket, and then opening a movable baffle (2) of the first-stage rocket to generate the resistance for the deceleration and the adjustment on the descending posture;
step b, turning on the turbine (8) to generate the compressed air and then deliver the compressed air, via an air tube, into a space above a piston separator (9) in an oxidizer chamber (3) as well as a space above a piston separator (9) in a fuel chamber (4); and
step c, driving the engine by means of the residual fuel to achieve the deceleration in the initial stage; and after the flameout of the engine, when a sensor detects that the rocket is about to reach the ground, opening a valve between the oxidizer chamber and an ejection opening as well as the fuel chamber and the ejection opening to make the compressed air be downwards ejected via the ejection opening from the bottom of the first-stage rocket, so as to generate the thrust for the deceleration, thus achieving safe landing of the rocket.
